(19) United States
(12) Patent Application Publication
(10) Pub. No.: US 2010/0032430 A1
(43) Pub. Date: Feb. 11, 2010

(54) MICROWAVE OVEN

(76) Inventor: Gunnar Olsson, Goteborg (SE)

Correspondence Address: HARNESS, DICKEY & PIERCE, P.L.C., P.O. BOX 8910, RESTON, VA, 20195, US

(21) Appl. No.: 12/312,987

(22) PCT Filed: Dec. 17, 2007
(86) PCT No.: PCT/SE2007/001109

§ 371 Date: Jun. 3, 2009

(30) Foreign Application Priority Data
Jan. 17, 2007 (SE) 0700088-8

(51) Int. Cl. H05B 6/68

(52) U.S. Cl. 219/706; 219/756

(57) ABSTRACT

A microwave oven, especially for personal use, includes a relay and a sound sensor. In at least one embodiment, the relay is connected to the sound sensor, arranged in the microwave oven, in such a manner that the supply of power by microwaves in the oven, when in use, is interrupted by the relay at a signal from the sound sensor when an acoustic signal is generated by a valve of a container being heated in the microwave oven.

### FIELD OF THE INVENTION

The present invention relates to a microwave oven, especially for personal use.

### BACKGROUND ART

Microwave ovens as stated above are of frequent occurrence and are rather often used for final heating of ready meals. Containers for ready meals are sometimes provided with instructions for how long something is to be heated and on which power the microwave oven is to be put. However the amount of food may vary in the containers, and above all the start temperature. In addition, not all microwave ovens are provided with setting options to set a specific power, for instance 600 W. This means that the user must have experience of the oven in combination with a specific dish in order to set the optimal time and power.

EP 1 424 874 discloses a microwave oven which comprises a control unit, which sets sampling intervals to accumulate humidity values detected by a humidity sensor. The microwave oven controls the cooking end time of the meal according to an accumulated humidity value obtained on detection of the humidity values from the sampling intervals. Consequently the microwave oven prevents the meal from being cooked too long, that is overcooked, for instance so that no further cooking is required after an initial generation of vapour. The microwave oven can set sampling intervals in a plurality of measurements in order to improve reliability. Moreover, a microwave oven can learn a process by setting the sampling intervals according to cooking conditions to complete a heating cycle according to the set sampling intervals where a subsequently set cooking condition corresponds to the cooking condition that has been learnt.

The amount of vapour generated thus varies according to what is being heated, which means that a microwave oven measuring the moisture content functions with different degrees of satisfaction for different dishes.

### SUMMARY OF THE INVENTION

The object of the present invention is to provide a microwave oven with a function that simplifies the cooking and/or the heating of ready meals.

This object is achieved by a microwave oven according to the invention as defined in the appended claims.

A microwave oven according to the present invention comprises a relay connected to a sound sensor arranged in the microwave oven in such a manner that the supply of power by microwaves in the oven in use is interrupted by the relay at a signal from the sound sensor when an acoustic signal is generated by a valve of the container to that being heated in the microwave oven. By the valves being adapted by the manufactures to generate sound according to what dish is to be heated, the handling is substantially simplified for the final user. In heating, a container provided with a sound-generating valve thus is placed in a microwave oven. For example, the highest power of the microwave oven is selected and a somewhat longer time is set on the microwave oven than is usually required for the heating. The setting of a longer time than is usually required thus means that with the present invention there is no risk of overcooking of the dish since the microwave oven stops supplying power at the acoustic signal from the valve of the container.

Preferably, the relay is in use arranged to interrupt the supply of power only after a duration of the acoustic signal of one second. This is advantageous since the microwave oven is not prematurely stopped due to a temporary signal which can be generated by temporary local generation of vapour or gas in the container. Moreover the microwave oven could be prematurely stopped without a stop time due to external factors such as the sound from a radio. Of course, it is possible to have a stop time which is both shorter and longer than one second. This could be solved, for example, with a special setting option of the microwave oven. This setting is preferably available, not only during manufacture in factory, but also for the buyer of the microwave oven, or alternatively the user.

In use, the relay is preferably arranged to interrupt the supply of power when the acoustic signal has a frequency between 200 and 1000 Hz. An acoustic signal in this range is relatively easy to generate using a simple valve, such as a valve made up of an adhesive layer arranged over an opening in the container. Basically any frequency can be used in the range which is normally audible to a human ear, that is 20 to 20 000 Hz. Sounds at higher frequencies can also be used since the switching off occurs as a result of a sound sensor detecting a sound. With a simple valve of the type mentioned above, the generated sound usually comprises a fundamental tone with noise, that is more than one frequency is involved. Valves are currently available, which generate acoustic signals at frequencies between about 440 Hz and 800 Hz.

In an alternative embodiment, a button is arranged on the microwave oven, comprising a time-independent start function. The purpose thus is that a container with food is first placed in the microwave oven, after which only one single pressing of the button will be required for heating of the food, and the heating is automatically switched off when the food is fully heated, that is when the valve emits an acoustic signal. As a measure of precaution it may be suitable to have a maximum time limiter if, for some reason, the valve should not function as intended. The maximum time and/or the power are preferably adjustable by the user.

Preferably the microwave oven has an adapter for connecting a computer. This is advantageous, for instance, in fault localisation. The microwave oven is preferably also programmable. With the introduction of “new” dishes which require a certain heating program, it is convenient to have the option of updating the microwave oven.

### BRIEF DESCRIPTION OF THE DRAWINGS

The invention will below be described with reference to the accompanying drawings.

FIG. 1 illustrates a microwave oven according to the present invention during heating.

FIG. 2 illustrates the microwave oven in FIG. 1 when the valve of the container has been opened.

FIG. 3 illustrates the microwave oven in FIG. 1 when the heating is terminated.

### DESCRIPTION OF PREFERRED EMBODIMENTS

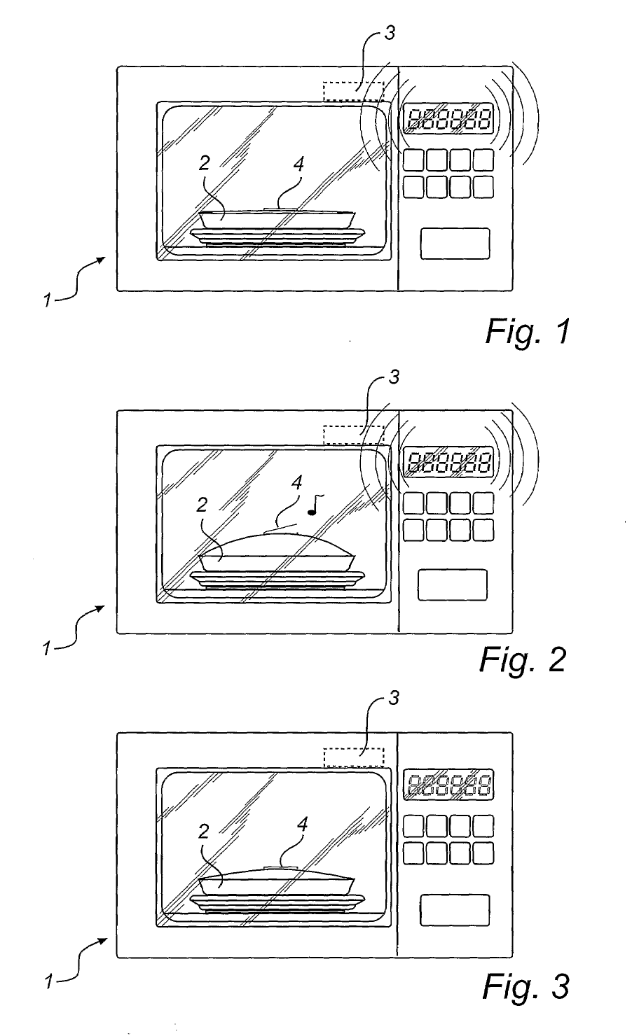

FIG. 1 illustrates a microwave oven 1 according to the present invention during heating of a container 2 with food. The dashed line forming a rectangle symbolises a sound sensor 3.

In FIG. 2, heating has been going on for a while and the valve 4 has been opened and emits an acoustic signal (symbolised by a note). The heating is terminated after an acoustic signal of about 1 s.

In FIG. 3, the heating has been terminated and the container 2 has begun to resume its original shape.

It will be appreciated that many modifications are conceivable within the scope of the invention as defined by the appended claims. For example, it would be possible to insert heating programs in the microwave oven 1 to allow optimising of the heating process according to the type of food that is being heated. For instance, the power could be varied in different steps. When, for instance, a signal has been generated, the power level could be lowered for a predetermined period, such as 60 s, thus ensuring a more even temperature distribution in the container. In this case the power could be equivalent to a normal power for keeping the food hot.

1. A microwave oven, comprising:
a relay; and
a sound sensor, connected to the relay and arranged in the microwave oven in such a manner that supply of power, by microwaves in the oven when in use, is interrupted by the relay at a signal from the sound sensor when an acoustic signal is generated by a valve of a container being heated in the microwave oven.

2. A microwave oven as claimed in claim 1, wherein the relay is arranged to interrupt the supply of power only after a duration of one second of the acoustic signal.

3. A microwave oven as claimed in claim 1, wherein the relay is arranged to interrupt the supply of power when the acoustic signal has a frequency between 200 and 1000 Hz.

4. A microwave oven as claimed in claims 1, wherein a button is arranged on the microwave over, including a time-independent start function.

5. A microwave oven as claimed in claim 4, further comprising a maximum time setting.

6. A microwave oven as claimed in claims 1, further comprising an adapter for connecting a computer.

7. A microwave oven as claimed in claims 1, wherein the microwave oven is programmable.

8. A microwave oven as claimed in claim 1, wherein the microwave oven is for personal use.

9. A microwave oven as claimed in claim 2, wherein the relay, in use, is arranged to interrupt the supply of power when the acoustic signal has a frequency between 200 and 1000 Hz.

10. A microwave oven as claimed in claim 2, wherein a button is arranged on the microwave over, including a time-independent start function.

11. A microwave oven as claimed in claim 10, further comprising a maximum time setting.

12. A microwave oven as claimed in claim 3, wherein a button is arranged on the microwave over, including a time-independent start function.

13. A microwave oven as claimed in claim 12, further comprising a maximum time setting.

14. A microwave oven as claimed in claim 2, further comprising an adapter for connecting a computer.

15. A microwave oven as claimed in claim 2, wherein the microwave oven is programmable.

16. A microwave oven as claimed in claim 3, further comprising an adapter for connecting a computer.

17. A microwave oven as claimed in claim 3, wherein the microwave oven is programmable.

18. A microwave oven, comprising:
a relay to interrupt a supply of power of the microwave oven; and
a sound sensor to signal the relay, the sound sensor signalling the relay to interrupt the supply of power, when the microwave oven is in use, upon sensing an acoustic signal generated by a valve of a container being heated in the microwave oven.

19. A microwave oven as claimed in claim 18, wherein the sound sensor signals the relay to interrupt the supply of power only after sensing an acoustic signal for duration of one second.

20. A microwave oven as claimed in claim 18, wherein the sound sensor signals the relay to interrupt the supply of power only after sensing an acoustic signal of a frequency between 200 and 1000 Hz.
